(19) United States
(12) Patent Application Publication
(10) Pub. No.: US 2022/0355514 A1
(43) Pub. Date: Nov. 10, 2022

(54) METHOD FOR MANUFACTURING A MOLDED PRODUCT HAVING A SURFACE WITH SUPPRESSED GLOSS

(71) Applicants: THE CHEMOURS COMPANY FC, LLC, WILMINGTON, DE (US); CHEMOURS-MITSUI FLUOROPRODUCTS CO., LTD, TOKYO (JP)

(72) Inventors: HOAI-NAM PHAM, SHIZUOKA (JP); KENJI SUZUKI, SHIZUOKA (JP)

(73) Assignees: THE CHEMOURS COMPANY FC, LLC, WILMINGTON, DE (US); CHEMOURS-MITSUI FLUOROPRODUCTS CO., LTD., TOKYO (JP)

(21) Appl. No.: 17/622,589

(22) PCT Filed: Jun. 25, 2020
(86) PCT No.: PCT/US2020/039480

§ 371 Date: Dec. 23, 2021

(30) Foreign Application Priority Data
Jun. 28, 2019 (JP) 2019-121922

(51) Int. Cl. B29C 37/00; C09D 127/18

(52) U.S. Cl. CPC B29C 37/0032; C09D 127/18

(57) ABSTRACT

Provided is a melt molding manufacturing method wherein the mold exhibits excellent molded product releasability over a long period of time, and that can produce a molded product having a matte surface with suppressed surface gloss. The molding manufacturing method for manufacturing the molded product involves forming the melt molded product in a mold having a coating on the surface of the mold, wherein the coating is a layer of fluororesin having dispersed therein oil and filler having an average particle size of 300 nm or less.

### CROSS-REFERENCE TO RELATED APPLICATIONS

This application claims priority to Japanese patent application no. JP2019-121922, filed Jun. 28, 2019, the disclosure of which is incorporated herein by reference in its entirety.

### FIELD OF THE INVENTION

The present invention relates to a method for manufacturing a molded product having a matte surface and more particularly to a method that can produce a molded product having a matte surface with good productivity and no surface gloss without impairing releasability during molding, along with a molded product obtained by this manufacturing method.

### BACKGROUND

Fluororesins have excellent heat resistance, chemical resistance, electrical properties, and mechanical properties, in addition to having low coefficients of friction as well as non-tackiness and water and oil repellency. This leads to wide use of fluororesins in all types of industrial fields such as chemical, machinery and electrical machinery industries. Because melt processable fluororesins in particular melt flow at temperatures above their melting point, the generation of pin holes can be suppressed when they are formed into coatings, thereby allowing the fluororesins to be used as coating compositions.

Fluororesin coatings utilizing the non-tackiness and water and oil repellency of fluororesins are used in cookware such as frying pans, rice cookers, office equipment such as fixing rolls/belts for fixing toners, and other various fields. Utility of these coatings has also extended to other fields of use such as inkjet nozzles and chemical plant equipment. There continues to be a strong commercial demand for coatings with enhanced and more durable non-tackiness and water and oil repellency.

For example, Patent Documents 1 and 2 below propose to form a fluororesin coating on a mold surface by utilizing the abovementioned non-tackiness possessed by fluororesins in order to enhance releasability when a polymer material, such as plastic or rubber, ceramic, cement, etc. are formed using a mold. It is also known to apply a release agent made from a fluorine based compound (Patent Documents 3, 4).

Conventional fluororesin coatings formed on mold surfaces are problematic in that the coatings lose releasability when molding is repeatedly carried out, making them not fully satisfactory in terms of durability. At the same time, conventional mold releasing agents have to be re-applied each time or every few times molding is performed, making them not fully satisfactory in terms of productivity.

To solve such problems, the present inventors have proposed fluororesin coating compositions formed by compounding a fluororesin and a fluoro oil having a higher decomposition temperature than the melting point of the fluororesin (Patent Document 5).

### PATENT DOCUMENTS

Patent Document 1: Japanese Unexamined Patent Application Publication (Translation of PCT Application) No. 2002-516618

Patent Document 2: Japanese Unexamined Patent Application Publication No. 2004-74646 A

Patent Document 3: Japanese Patent No. 2658172

Patent Document 4: Japanese Unexamined Patent Application Publication No. 2011-63709 A

Patent Document 5: Japanese Unexamined Patent Application Publication No. 2018-90772 A

### SUMMARY OF THE INVENTION

Molds having a coating film of the abovementioned fluororesins exhibit suitable releasability (non-tackiness) over a long period of time, in addition to achieving suitable durability and wear resistance.

However, products molded using such fluororesin coated molds have significant surface gloss, which can be undesirable in certain molded products. Molded products having a matte surface with suppressed gloss are desirably formed in some applications. Furthermore, while Patent Document 1 provides a matted molded product having a coated mold surface comprising a coating composition containing inorganic filler particles coated with a fluoropolymer powder, it has been problematic in that it is inferior to a mold surface with the coating film consisting of the abovementioned fluororesin coating composition formed thereon in terms of releasability of the molded product along with the long term durability thereof.

Therefore, objects of the present invention are to provide a manufacturing method for a molded product wherein the mold exhibits excellent releasability of molded products from the mold over a long period of time and many molding cycles, in addition to producing molded products having a matte surface with suppressed surface gloss.

In accordance with the present invention, provided is a method for manufacturing a molded product using a mold having a coating film comprising a fluororesin coating composition formed on the surface of the mold, wherein the coating film comprises fluororesin and dispersed oil and a filler having an average particle size of 300 nm or less.

In the present manufacturing method, the following are preferred embodiments:

1. The molded product has a glossiness of less than 8;

2. The fluororesin is a melt processable perfluoro resin;

3. The oil is an oil that is in the liquid phase at 25° C. and atmospheric pressure;

4. The content of the oil in the fluororesin coating composition is 1 to 35 wt % of the total amount of resin solids and oil in the coating composition; and

5. The filler content in the fluororesin coating composition is 1 to 10 wt % of the total amount of resin solids and filler in the coating composition.

Further provided is a molded product made from a polymer, the molded product being molded in a mold having a surface coating film comprising fluororesin, an oil and a filler having an average particle size of 300 nm or less, and the molded product having a glossiness of less than 8.

In the present method for manufacturing a molded product, by using a mold having a coating film comprising fluororesin, oil and a filler with an average particle size of 300 nm or less formed on the surface of the mold, a molded product having a matte surface with suppressed surface gloss can be molded. Moreover, since the mold has excellent releasability of molded products from the mold surface along with excellent durability and wear resistance of the mold surface, molded products having a matte surface can be molded with good productivity over a long period of time.

In the present invention, by using a filler with a small particle size having an average particle size of 300 nm or less in the present coating film, it is possible to make the surface of the molded product matte with a small added amount of filler to the coating film, in addition to also effectively preventing a reduction in the mold releasability of the mold due to the small amount of filler added.

### DESCRIPTION OF THE PREFERRED EMBODIMENTS

In the present method for manufacturing a molded product, an important characteristic is the use of a mold in which a coating film comprising fluororesin and dispersed oil and filler having an average particle size of 300 nm or less is present on the surface of the mold.

### Fluororesin Coating Composition

The coating composition constituting the coating film formed on the mold surface is a fluororesin coating composition containing a fluororesin, an oil, and a filler having an average particle size of 300 nm or less.

Because the coating composition contains a fluororesin, with excellent non-tackiness along with water and oil repellency, and an oil, wherein the oil is homogeneously dispersed throughout the coating film, the oil will seep from the fluororesin coating film surface, further enhancing the non-tackiness of the fluororesin coating film.

The oil used in the fluororesin coating film of the present method preferably has a decomposition temperature that is higher than the melting point of the fluororesin. Thus, even if the coating composition is coated and heat treated at a temperature near the melting point of the fluororesin, the oil will not decompose and volatilize into a gas. As a result, not only will the abovementioned effect, brought on by the oil, not be impaired, but the generation of coating film defects, such as bubbles caused by volatilization of the oil, is effectively prevented.

Furthermore, in the present method, because the oil is present in a dispersed state throughout the coating composition, the oil is present in a dispersed state throughout the thickness of the coating film. Therefore, when the coating film is worn due to use, the oil inside the coating film gradually seeps from the surface thereof, making it possible to express a high level of non-tackiness as the coating film wears over a long period of time.

To effectively achieve the abovementioned effect, obtainable because the oil is present in a dispersed state throughout the thickness of the coating film, the average particle diameter of the oil dispersion in the coating composition is preferably 50 μm or less, more preferably 20 μm or less, and particularly preferably 10 μm or less. Note that the method for measuring the average particle diameter of the dispersed oil will be described later.

In the present invention, as was described above, the decomposition temperature of the oil is preferably higher than the melting point of the fluororesin. Specifically, it is desirably at least 10° C. higher, preferably at least 30° C. higher, and more preferably at least 50° C. higher than the melting point of the fluororesin. Consequently, the effects on the oil during heat treating coating film formation can be reliably reduced, thus ensuring further enhancement of the non-tackiness of the coating film by the oil.

The melting point of the fluororesin according to the present method is the temperature corresponding to the melting peak measured using a Differential Scanning calorimeter (DSC) based on ASTMD 3307. The decomposition temperature of the oil is the temperature derived by calculating the results of a thermal gravity measurement (TGA) using the method disclosed in JIS K7120. The detailed measuring methods of each will be described later in the Examples.

By including oil in the coating composition forming the coating film on the mold surface, wear is reduced by oil seeping from the coating film surface, thereby enhancing the wear resistance of the coating film.

Furthermore, in the present process, a filler having an average particle size of 300 nm or less is contained in the coating composition together with the fluororesin and the oil. Due to the inclusion of such a filler, it is possible to further improve wear resistance in conjunction with the presence of the oil, the mold surface can exhibit excellent releasability over a long period of time, and exhibit excellent productivity. Furthermore, by including a filler having the abovementioned average particle size in the coating film formed on the mold surface, it is possible to manufacture a molded product having a matte surface with suppressed surface gloss, as described below.

In the present method, as long as the coating composition for forming a coating film on the mold surface includes a combination of the abovementioned fluororesin, oil, and filler, the composition may be any form of water based coating composition, solvent based coating composition, or powder coating composition, with water based coating compositions or powder coating compositions being preferable from an environmental and cost perspective. Furthermore, powder coating compositions can form very thick coating films.

### Fluororesin

Exemplary fluororesins constituting the coating composition include, but are not limited to, polytetrafluoroethylenes (PTFE), tetrafluoroethylene perfluoro (alkyl vinyl ether) copolymers (PFA), tetrafluoroethylene hexafluoropropylene copolymers (FEP), tetrafluoroethylene hexafluoropropylene perfluoro (alkyl vinyl ether) copolymers, tetrafluoroethylene ethylene copolymers, polyvinylidene fluorides, polychlorotrifluoroethylenes and chlorotrifluoroethylene ethylene copolymers.

From the perspective of being able to suppress the generation of pin holes and obtain a uniform smooth coating film when the coating film is formed, a melt processable fluororesin exhibiting melt flowability above the melting point thereof is preferably used. From the perspective of coating film non-tackiness and heat resistance, a heat processable perfluoro resin, such as a low molecular weight PTFE, PFA, FEP, or tetrafluoroethylene hexafluoropropylene perfluoro (alkyl vinyl ether) copolymer is preferably used, with PFA being most preferred.

The alkyl group of the perfluoro (alkyl vinyl ether) in the PFA preferably has 1 to 5 carbon atoms, wherein among these, perfluoro (propyl vinyl ether) (PPVE), perfluoro (ethyl vinyl ether) (PEVE), and perfluoro (methyl vinyl ether) (PMVE) are particularly preferable. The amount of perfluoro (alkyl vinyl ether) in the PFA is preferably in a range of 1 to 50 wt %.

For the fluororesin of the present invention, a high molecular weight PTFE that does not exhibit melt flow even at or above the melting point can be used along with a heat processable perfluoro resin. Because the high molecular weight PTFE particles also serve as a filler, it is also possible to enhance the releasability while achieving the effect of improving the durability of the coating film and reducing the glossiness of the molded product of the present invention.

A PTFE aqueous dispersion obtained by emulsion polymerization is preferably used as such PTFE.

### Oil

The oil contained in the present coating composition preferably is in the liquid phase at ambient temperature (25° C.) and pressure, and has a higher decomposition temperature than the melting point of the fluororesin.

As described above, since PFA is most preferably used as the fluororesin, the oil decomposition temperature is preferably sufficiently higher than 300 to 310° C., which is the melting point of PFA. Specifically, the oil decomposition temperature is preferably 350° C. or higher.

Furthermore, because the purpose of the oil is to seep from the surface of the present fluororesin coating film and further improve the non-tackiness of the fluororesin coating film, the surface tension of the oil itself is preferably small, with the surface tension at 25° C. being preferably 30 mN/m or less, more preferably 20 mN/m or less.

In order to satisfy such conditions, oils with excellent heat resistance and low intermolecular interaction are required, with examples including fluorine oils, silicone oils, modified silicone oils, and alkanes with 15 to 100 carbon atoms, higher fatty acids with 5 to 50 carbon atoms, fatty acid esters, hydrocarbon based oils such as a polyol ester, a polyglycol, a polyether, or a polyphenyl ether. While these can be used alone or in combination, in the present invention, a fluoro oil or silicone oil can be suitably used.

Exemplary fluoro oils include, but are not limited to, perfluoropolyethers (PFPE), perfluoroalkyl polyethers, and telomers of fluorinated monomers (for example, tetrafluoroethylenes (TFE), ethylene trifluorides, vinylidene fluorides, chlorotrifluoroethylenes (CTFE), fluorinated acrylic monomers), and other specific fluorinated hydrocarbon compounds.

PFPE having low surface energy and capable of efficiently enhancing the non-tackiness of the coating film can be suitably used in the present invention, in addition to being capable of being obtained using products going by the commercial names of Kryto® (available from The Chemours Company) or DEMNUM® (available from Daikin Industries, Ltd.), etc.

Exemplary silicone oils include, but are not limited to, straight silicone oils such as dimethyl silicone oils, methyl phenyl silicone oils, and methyl hydrogen silicone oils, reactive modified silicone oils such as monoamine modified silicone oils, diamine modified silicone oils, amino modified silicone oils, epoxy-modified silicone oils, alicyclic epoxy-modified silicone oils, carbinol-modified silicone oils, mercapto-modified silicone oils, carboxyl-modified silicone oils, hydrogen-modified silicone oils, amino polyether-modified silicone oils, epoxy polyether-modified silicone oils, and epoxy aralkyl-modified silicone oils, and non-reactive modified silicone oils such as polyether-modified silicone oils, aralkyl-modified silicone oils, chloroalkyl-modified silicone oils, halogen-modified silicone oils, long chain alkyl-modified silicone oils, higher fatty acid ester-modified silicone oils, higher fatty acid amide-modified silicone oils, polyether long chain alkyl aralkyl-modified silicone oils, long chain alkyl aralkyl-modified silicone oils, etc. Among these, methyl phenyl silicone oils that can also be used in food applications can be suitably used.

### Filler

The filler contained in the present coating composition is not particularly limited as long as the average particle size is 300 nm or less, with the filler capable of being selected and used from various conventionally known organic and inorganic fillers.

Exemplary organic fillers include, apart from high molecular weight PTFE that can be used as described above, engineering plastics, such as polyarylene sulfides, polyether ether ketones, polyamides and polyimides. High molecular weight PTFE is preferably used because it can also improve the releasability of the coating film. Exemplary inorganic fillers include metal powders, metal oxides (aluminum oxide, zinc oxide, tin oxide, titanium oxide), glass, ceramics, silicon carbides, silicon oxides, calcium fluorides, carbon black, graphites, micas and barium sulfates. Regarding the shape of the filler, exemplary fillers include fillers having a variety of shapes, such as particle shaped, fiber shaped and flake shaped fillers.

As described above, while the mold used in the present invention has improved releasability and wear resistance due to the presence of oil, by compounding a filler, wear resistance can be further improved, and excellent releasability can be achieved over a long period of time. Exemplary particularly preferable fillers include, but are not limited to, silicas, carbon blacks, silicon carbides (SiC), and polyimides (PI).

While it is important that the filler have an average particle size of 300 nm or less, the filler preferably has an average particle size of 250 nm or less, more preferably 150 nm or less, and particularly preferably 30 nm or less. The smaller the average particle size, the lower the amount of filler to be added to obtain the effect of making the surface of the molded product matte; moreover, the lower the amount of filler added, the smaller the decrease in releasability of the coating film. Note that the average particle size of the filler refers to the particle size at an integrated value of 50% (volume basis) in particle size distribution obtained by laser diffraction/scattering.

When the present coating composition is a liquid coating such as a water based coating, the filler can be used by dispersing the filler in a liquid medium such as water or the like. When the coating composition is a powder coating, a method such as dry blending that mixes the coating composition powder and the filler directly, or a coaggregation method or the like in which a filler is added to an aqueous dispersion, then stirred and aggregated together, can be used.

### Preparation of the Coating Composition

The oil in the coating composition to be coated on the mold surface used in the present manufacturing method is preferably contained in an amount of 1 to 35 wt %, particularly preferably 5 to 20 wt %, of the total weight of resin solids (weight of the fluororesin contained in the coating composition) and oil in the coating composition. If the amount of the oil is below the abovementioned range, there is a risk that it will not be possible to sufficiently enhance the non-tackiness of the coating film compared to cases in which the amount is within the abovementioned range. When the amount of the oil is above the abovementioned range, there is a risk that coating film defects may occur more readily compared to cases in which the amount is within the abovementioned range.

The filler is desirably contained in an amount of 1 to 10 wt %, preferably 2 to 8 wt %, more preferably 3 to 6 wt %, of the total weight of resin solids (weight of the fluororesin contained in the coating composition) and oil in the coating composition. If the amount of the filler is less than the abovementioned range, then the gloss of the surface of the molded product obtained cannot be suppressed compared to when in the abovementioned range; moreover, even if a matte surface is obtained, there may be unevenness and a matte molded product having excellent appearance characteristics may not be obtained. On the other hand, if the amount of the filler is greater than the abovementioned range, the releasability of the mold surface decreases compared to when in the abovementioned range, which is not preferable. However, this is not the case for high molecular weight PTFE particles, because the releasability can be further improved. Additionally, a combination of high molecular weight PTFE particles and other fillers can also be used and, along with the effect of suppressing the gloss of the surface of the molded product via the high molecular weight PTFE particles, other performances can be improved depending on the filler used in combination. For example, both effects can be obtained by using a combination of high molecular weight PTFE particles and SiC with a large effect of improving the wear resistance of the coating film.

Furthermore, the content of the fluororesin is desirably at least 80 wt %, particularly preferably at least 90 wt %, based on the coating solids (the entire solids left behind as the coating film excluding the oil) of the coating composition from the perspective of adequately providing the coating film with the characteristics described above, such as the heat resistance, chemical resistance, etc., possessed by fluororesins.

When PTFE is contained as the fluororesin along with the heat processable perfluoro resin, the PTFE is preferably contained in the resin solids of the coating composition in a range of 50 wt % or less, particularly preferably 5 to 30 wt %.

While, as was described above, the coating composition used in the present method may be any form of water or solvent based coating composition or powder coating composition as long as it contains a fluororesin, an oil, and a filler having an average particle size of 300 nm or less, the composition is, from an environmental perspective, preferably a water based coating composition or powder coating composition. Furthermore, exemplary methods for preparing the coating composition include, but are not limited to, the methods described below.

### Water Based Coating Composition

When the coating composition is prepared as a water based coating composition, the composition can be prepared using a method that mixes an oil, a filler, or other additives to be described later, in an aqueous dispersion of fluororesin and a liquid mixture (for example, an existing fluororesin water based coating, etc.) thereof, or using a method that mixes a powder of a fluororesin in an oil, a filler, and an aqueous solvent together with other additives.

The fluororesin aqueous dispersion used in the coating composition can be prepared by dispersing the fluororesin evenly and stably in an aqueous solution using a surfactant, or by polymerizing the fluororesin with a water based emulsion using a surfactant and an initiator, or a chain transfer agent or the like, as necessary.

While the abovementioned fluororesin aqueous dispersion can be used as is in the water based coating composition, a filler and a variety of additives, for example, surfactants (examples thereof include polyoxyethylene alkyl ether, polyoxyethylene alkyl phenyl ether type nonionic surfactants such as LEOCOL® available from LION, Inc., the TRITON® and TERGITOL® series available from the Dow Chemical Company, and EMALGEN® available from KAO, Inc.; sulfosuccinates such as LIPAL® available from LION, Inc., EMAL®, PELEX®, available from KAO, Inc.; and polycarboxylate, acrylic salt type polymer surfactants, such as alkyl ether sulfonic acid sodium salts, sulfate mono-long chain alkyl based anionic surfactants, LEOAL® available from LION, Inc., OROTAN® available from the Dow Chemical Company), film forming agents (examples include polymeric film forming agents such as polyamides, polyamide imides, acrylics, acetates; higher alcohols and ethers; polymeric surfactants having a film forming effect), and thickeners (examples include soluble celluloses, solvent dispersion thickeners, sodium alginates, caseins, sodium caseinates, xanthan gums, polyacrylic acids, acrylic esters) used in normal coatings can be added thereto in accordance with the required characteristics such as dispersibility, conductivity, foaming prevention and improved wear resistance.

While the oil can be used in the coating composition used for coating the mold surface of the present invention alone, as was described above, a surfactant is preferably used in combination therewith so that the oil can be well dispersed in the composition. Conventionally known surfactants can be used as the surfactant used to improve oil dispersibility.

Furthermore, so that the oil is well dispersed, the oil is preferably dispersed using ultrasonic dispersion or a high shear rate in conjunction with using the abovementioned surfactant. A commonly used ultrasonic disperser, stirrer, or a variety of homogenizers (high pressure, high speed, ultrasonic) can be used for these dispersions. Through the use thereof, the oil can be well dispersed without being diluted using a solvent, which is preferable from the perspective that doing so simplifies the process and lowers costs related to the use of the solvent. Furthermore, the abovementioned dispersion can naturally be carried out after the oil has been diluted with the solvent, with better dispersion expected as a result of doing so.

### Solvent Based Coating Composition

Furthermore, when the coating composition is prepared as a solvent based coating composition, the composition can be prepared using a method that mixes a powder of a fluororesin in an oil, a filler, and a solvent along with other additives, or using a method that adds an oil, a filler, and other additives to a fluororesin solution.

### Powder Coating Composition

Additionally, when the coating composition is prepared as a powder coating composition, the composition can be prepared using a method such as dry blending that mixes the fluororesin coating composition powder and the filler directly, or a method that simultaneously aggregates (co-aggregates) a fluororesin aqueous dispersion and an oil and a filler to obtain a composite fluororesin powder.

To the fluororesin aqueous dispersion, the oil, suitably the abovementioned oil dispersion, is compounded to be in an amount of 1 to 35 wt % of the total weight of the resin solids (weight of the fluororesin contained in the coating composition) and the oil in the coating composition, and a filler is compounded to be in an amount of 1 to 10 wt % of the total weight of the resin solids (weight of the fluororesin contained in the coating composition) and the filler in the coating composition, which is then agitated to coaggregate the fluororesin, the oil, and the filler. Furthermore, PTFE dispersions can be used in combination. After granulating the aggregated granules by stirring the granules for 10 to 60 minutes at a stirring speed of 100 to 500 rpm such that average particle diameter becomes 1 to 200 μm, the oil and the filler is made—through separating, washing, and drying—to fill voids in the primary particles of the fluororesin, thereby allowing a composite powder of the fluororesin/oil/filler in which the oil dispersion and the filler is uniformly present to be prepared. Large coarse particles with particle diameters of at least 200 μm generated by aggregation or over-granulation can be crushed into fine particles as necessary.

Note that an electrolytic material, such as HCl, H₂SO₄, HNO₃, H₃PO₄, Na₂SO₄, MgCl₂, CaCl₂), HCOONa, CH₃COOK, and (NH₄)₂CO₃, is preferably compounded to cause the fluororesin primary particles to be chemically aggregated. Additionally, an organic solvent incompatible with water (preferably a fluorinated solvent) is preferably added as needed so as to uniformly granulate the aggregated particles.

### Mold

In the present method for manufacturing a molded product, a mold having a film formed on the surface from the abovementioned fluororesin coating compositions is used. The film comprises fluororesin and dispersed oil and filler, and is formed on the mold surface in contact with the molded product.

The mold can be appropriately selected in accordance with the molding method capable of molding the intended molded product and can be manufactured by conventionally known molding methods including, without limitation, injection molding, compression molding, vacuum forming, blow molding, press molding, and transfer molding.

Exemplary base materials constituting the mold preferably include, but are not limited to, base materials that can withstand heat treating, such as metal base materials, like aluminum, iron, stainless steel, glass, ceramic, and heat resistant plastic base materials.

In the present method, a surface coating film is formed by coating the abovementioned coating composition on the mold surface. When the coating composition is a liquid (water or solvent based) coating composition, the composition can be coated by a sprayed coating, dipped coating, while when it is a powder coating composition, it can be coated using a conventionally well-known coating method, such as electrostatic coating.

After coating, a coating film is preferably formed by subjecting the coated coating composition to heat treatment at or above the melting point of the fluororesin. This makes it possible to melt the fluororesin of the coated coating composition causing it to flow and thus form an even coating film.

While the thickness of a surface coating film of the mold may be appropriately selected based on the application and the portion to which the film will be applied, coating so as to create a film thickness after a heating and melting process of at least 5 μm, particularly in a range of 5 to 300 μm, is preferred. If the film thickness is thinner than the abovementioned range, there is a risk that continuous coating film formation will be impossible, causing more coating film defects than when the thickness is within the abovementioned range, in addition to a risk that the coating film will lose performance (non-tackiness (releasability) and water and oil repellency) due to wear at an early stage; at the same time, economic efficiency is lost when the film thickness is thicker than in the abovementioned range.

While the coating of the abovementioned coating composition onto the mold can be applied directly to the mold surface, surface adhesion may be increased by applying a primer coating or surface chemical treatment to the mold surface. A variety of engineering plastic resins (for example, polyimides, polyamides, polyamide imides, polyether imides, polyarylene sulfides, and polyether ether ketones) highly adhesive with respect to base materials are preferably included as primer coatings. Furthermore, fluororesins, particularly PFA, are preferably included to enhance interlayer adhesion with the coating film produced by the present coating composition. In order to make adhesion to both the coating film produced by the present coating composition and the base material satisfactory, the percentage of the fluororesin in the primer coating is preferably 50 to 90 mass %, while the percentage of the engineering plastic resin and the filler in the primer is preferably 10 to 50 mass %.

Because the surface coating film formed on the mold surface has a high degree of non-tackiness and water and oil repellency, the oil contact angle is desirably at least 58 degrees, preferably at least 60 degrees.

Furthermore, oil is contained in the surface coating film in an amount of 1 to 35 wt %, in particular 5 to 20 wt %, and the filler is contained in an amount of 1 to 10 wt %, preferably 2 to 8 wt %, and particularly preferably 3 to 5 wt %, allowing the non-tackiness (releasability) of the coating film to be expressed over a long period of time. Moreover, the surface gloss of the obtained molded product is less than 8, preferably no greater than 5, more preferably no greater than 3, and particularly preferably no greater than 1, allowing a molded product having a matte state surface to be obtained.

### Molded Product

The molded product of the present process can be formed from a conventionally known polymer material that can be molded by a molding method using the abovementioned mold, and can be formed from a thermoplastic resin, a thermosetting resin, a photocurable resin, an electron beam curing resin, or other resin or resin composition, a rubber, or a thermoplastic elastomer.

Exemplary thermoplastic resins include, but are not limited to, olefin resins such as polyethylene and polypropylene, polyester resins such as polyethylene terephthalate and polybutylene terephthalate, acrylic resins such as polymethyl methacrylate, polycarbonate, polyimide, and polyamide resins.

Exemplary thermosetting resins include, but are not limited to, phenol resins, epoxy resins, melamine resins, unsaturated polyester resins, and silicone resins.

Exemplary photocurable resins include, but are not limited to, 1 to 2 functional monomers having one or more (meth) acryloyl groups per molecule, acrylic resins consisting of multifunctional monomers, multifunctional oligomers, or multifunctional polymers. Exemplary electron beam curing resins include, but are not limited to, epoxy acrylate, polyester acrylate, polyurethane acrylate, epoxy methacrylate, polyester methacrylate, and polyurethane methacrylate.

Exemplary rubbers include ethylene-propylene copolymers, ethylene-α-olefin copolymers, propylene-α-olefin copolymers, chlorinated polyethylene, saturated polyolefin based rubbers such as chlorosulfonated polyethylene, ethylene-propylene-diene copolymers, α-olefin-diene copolymers, ethylene-diene copolymers, and propylene-diene copolymers; α-olefin diene copolymer rubbers such as halides and hydrogenated products thereof, isoprene rubbers, butadiene rubbers, diene copolymer rubbers such as halides and hydrogenated products thereof, silicone based rubbers such as methyl silicone rubbers, vinyl methyl silicone rubbers, and phinyl methyl silicone rubbers; fluororubbers such as fluorinated silicone rubbers, fluorinated vinylidene rubbers, tetrafluoroethylene-propylene rubbers, and tetrafluoroethylene-perfluoromethyl vinyl ether rubbers; styrene-diene copolymer rubbers such as styrene-butadiene copolymers and styrene-isoprene copolymers; butyl based rubbers such as butyl rubbers and halides and hydrogenated products thereof; chloroprene based rubbers such as chloroprene rubbers and chloroprene and halides and hydrogenated products thereof; epichlorohydrin based rubbers such as epichlorohydrin rubbers and epichlorohydrin-ethylene oxide rubbers, urethane rubbers such as polyetherurethane rubbers and polyesterurethane rubbers; acrylonitrile-butadiene based rubbers such as acrylonitrile-butadiene rubbers and halides and hydrogenated products thereof; and natural rubbers.

Exemplary thermoplastic elastomers include polystyrene based thermoplastic elastomers such as styrene-butadiene-styrene block copolymers, styrene-isoprene-styrene block copolymers, styrene-ethylene-butadiene-styrene block copolymers, styrene-isoprene-butadiene-styrene block copolymers, and styrene-ethylene-propylene-styrene block copolymers, and halides and hydrogenated products thereof; polyolefin based thermoplastic elastomers such as blends of olefin resins and olefin rubbers and blends of olefin resins and olefin-diene copolymers, and halides and hydrogenated products thereof; polyurethane based thermoplastic elastomers, and polyester based thermoplastic elastomers.

To the abovementioned polymer material constituting the molded product, depending on the material used, a crosslinking agent, a polymerization initiator, a filler, a pigment, an ultraviolet absorber, an anti-aging agent, a foaming agent, an antifoaming agent, or an antioxidant can be added by conventional known formulations.

Because the manufacturing method of the present invention can impart a matte surface to a molded product, it is particularly suitable for molding a molded product having a favorable matte appearance. It can suitably mold items including, without limitation, rubber products such as various types of tires (automobile tires, aircraft tires, bicycle tires), rubber crawlers, and other industrial rubber products (rubber belts, rubber hoses, vibration-damping rubbers), industrial mechanical components such as containers, bodies, and carriers, and resin products such as various daily products.

### EXAMPLES

### Mold Surface Coating Film Creation Process

A base material and coating film for use in mold performance evaluation were produced using the following procedure.

### (1) Base Material Surface Treatment

The surface of an aluminum base material (JIS A5052 compliant material, 50 mm×100 mm, 1 mm thick) was degreased using isopropyl alcohol, and then, a sandblaster (Numablaster SGF-4(A)S-E566, available from Fuji Manufacturing Co., Ltd.) was used to subject the surface to roughening by shot blasting using #60 alumina (Showa Blaster, available from Showa Denko KK).

### (2) Undercoating (Primer Application)

A coating was applied to the base material treated as described in (1) above using an air spray coating gun (W-88-10E2 φ 1 mm nozzle (manual gun)), available from Anest Iwata Corporation) to spray a liquid primer coating EJ-CL107/SJ-CL600 (available from Chemours-Mitsui Fluoroproducts Co., Ltd.) at an air pressure of 2.5 to 3.0 kgf/cm². Coating was done so that a coated liquid mass was approximately 0.15 g (0.10 to 0.20 g) per sheet of base material, and then, drying was performed in a forced draft circulation furnace at 120° C. for 30 minutes and firing was performed at 380° C. for 30 minutes to form a coating film with a film thickness of 4 to 8 μm. The coating environment was 25° C. with humidity of 60% RH.

### (3) Coating Formation by Overcoating

A coating was applied to the base material treated as described in (1) and (2) above using an air spray coating gun (W-88-10E2 φ 1 mm nozzle (manual gun), available from Anest Iwata Corporation) to spray liquid coating compositions obtained in Examples 1 to 9 and Comparative Examples 2 to 7 to be described later at an air pressure of 2.5 to 3.0 kgf/cm² (the coating method of Comparative Example 1 will be described later). Coating was done so that a coated liquid mass was approximately 0.4 g (0.35 to 0.45 g) per sheet of base material, and then, drying was performed in a forced draft circulation furnace at 120° C. for 30 minutes followed by a further heat treatment at 340° C. for 60 minutes to form a coating film with a film thickness of 20 to 25 μm. The coating environment was 25° C. with humidity of 60% RH.

A 30 g of carbon black Thermax® N990 available from CANCARB Limited was added to 100 g of the fluorine rubber Viton® GBL200-S available from Chemours Company, and then kneading was performed using an open roll machine to obtain a rubber composition. An unapplied substrate aluminum (JIS A5052 compliant, 50 mm×100 mm, 1 mm thick) was placed in a predetermined mold (100 mm×50 mm, 4 mm high), and the obtained rubber composition was placed thereon, and a test piece (dimensions 100 mm×50 mm) coated by the abovementioned method was further placed thereon such that the coating film came into contact with the rubber composition. Using a compression molding machine (hot press WFA-37 available from Shinto Metal Industries, Ltd., cylinder diameter: 152 mm), a rubber molded product was obtained by performing a heating press for 10 minutes at a temperature of 185° C. and a cylinder internal pressure (hydraulic pressure) of the compressor of 5 MPa.

### Decomposition Temperature of the Fluoro Oil

The temperature of approximately 50 mg of fluoro oil was raised 10° C. per minute from room temperature to 600° C. in a nitrogen atmosphere using a thermogravimetric analyzing device (TGA2050: available from TA Instruments, Inc.), and a temperature calculated using the method disclosed in JIS K7120 from an obtained temperature-weight curve was used as a decomposition temperature.

### Gloss Evaluation Measurement Method

The glossiness of the surface of the obtained rubber molded product that was in contact with the coating film was measured at room temperature using a Handy Gloss Meter IG-320 available from Horiba, Ltd.

### Coating Film Wear Resistance Test (Suga WR)

For the test piece (dimensions 100 mm×50 mm) coated by the abovementioned method, a wear resistance test was performed using a Suga Wear Testing Machine NUS-1503 available from Suga Test Instruments Co., Ltd., in accordance with JIS K5600-5-10 (test piece reciprocating method). The test conditions were as described below.

Load: 1 N

Number of reciprocations: 100 (stroke 30 mm)

Abrasive paper used: Silicon carbide paper, P-400 grade (12 mm wide)

From the change in the measured mass before and after measurement, wear resistance (WR) was determined by the following calculation equation. Measurement was made with n=4 times and the average values obtained are shown in Table 1.

$$WR = \frac{NSρ}{10 ( W 1 - W 2 )} [ d s / μ m ] \qquad [ Equation 1 ]$$

N: number of reciprocations (ds: double strokes)

W1: mass before testing (mg)

W2: mass after testing (mg)

S: area of the wear portion (cm²)

ρ: test material density (g/cm³)

Value inserted from experimental condition: N: 100 ds

S: 1.2 cm×3 cm

ρ: 2.12 g/cm³ (* an average specific gravity value of PFA was applied)

Releasability Evaluation (n-Hexadecane Contact Angle)

A contact angle (droplet size: approximately 2 μL) of n-hexadecane was measured using a fully automatic contact angle meter (Kyowa Interface Science Co., Ltd., DM-701) in a measurement environment of 25° C., and humidity of 60%.

### Example 1

As fluoro oil, 12.05 g of PFPE (Krytox XHT1000, available from Chemours Company, decomposition temperature 426° C.) and 24.1 g of a fluorine based surfactant (FS-31, available from Chemours Company) were placed in a 1 liter stainless steel beaker; ultrasonic dispersion treatment was performed for 5 minutes using an ultrasonic generator (Ultrasonic MINIWELDER HS3-4, available from Ultrasonic Engineering Co., Ltd.); then as fluororesin (PFA) water based coating for top coat, 455.76 g of EJ-500CL (average particle size of included PFA: approximately 0.2 μm, melting point: 309° C., PFA resin solids: 35 wt %), available from Chemours-Mitsui Fluoroproducts Co., Ltd., was added; the mixture was stirred for 5 minutes in 300 rpm using a downflow type propeller type 4-bladed stirrer; and then 8.09 g of a silica dispersion liquid (SnowtexC available from Nissan Chemical Corporation, particle size: 10 to 15 nm, silica solids: 20 wt %) was added and stirred for another 15 minutes. The obtained coating composition was coated onto an aluminum base material which had been subjected to a primer treatment using the method described above, and thus a coating film sample was produced.

Fluoro oil content relative to the total amount of resin solids and oil of the fluororesin coating composition: 7.0 wt %, and filler (silica) content relative to the total amount of resin solids and filler of the fluororesin coating composition: 1.0 wt %

### Example 2

As fluoro oil, 11.86 g of PFPE (Krytox XHT1000, available from Chemours Company, decomposition temperature 426° C.) and 23.71 g of a fluorine based surfactant (FS-31, available from Chemours Company) were placed in a 1 liter stainless steel beaker; ultrasonic dispersion treatment was performed for 5 minutes using an ultrasonic generator (Ultrasonic MINIWELDER HS3-4, available from Ultrasonic Engineering Co., Ltd.); then as fluororesin (PFA) water based coating for top coat, 448.36 g of EJ-500CL (average particle size of included PFA: approximately 0.2 μm, melting point: 309° C., PFA resin solids: 35 wt %), available from Chemours-Mitsui Fluoroproducts Co., Ltd., was added; the mixture was stirred for 5 minutes in 300 rpm using a downflow type propeller type 4-bladed stirrer; and then 16.07 g of a silica dispersion liquid (SnowtexC available from Nissan Chemical Corporation, particle size: 10 to 15 nm, silica solids: 20 wt %) was added and stirred for another 15 minutes. The obtained coating composition was coated onto an aluminum base material which had been subjected to a primer treatment using the method described above, and thus a coating film sample was produced.

Fluoro oil content relative to the total amount of resin solids and oil of the fluororesin coating composition: 7.0 wt %, and filler (silica) content relative to the total amount of resin solids and filler of the fluororesin coating composition: 2.0 wt %

### Example 3

As fluoro oil, 11.66 g of PFPE (Krytox XHT1000, available from Chemours Company, decomposition temperature 426° C.) and 23.32 g of a fluorine based surfactant (FS-31, available from Chemours Company) were placed in a 1 liter stainless steel beaker; ultrasonic dispersion treatment was performed for 5 minutes using an ultrasonic generator (Ultrasonic MINIWELDER HS3-4, available from Ultrasonic Engineering Co., Ltd.); then as fluororesin (PFA) water based coating for top coat, 441.05 g of EJ-500CL (average particle size of included PFA: approximately 0.2 μm, melting point: 309° C., PFA resin solids: 35 wt %), available from Chemours-Mitsui Fluoroproducts Co., Ltd., was added; the mixture was stirred for 5 minutes in 300 rpm using a downflow type propeller type 4-bladed stirrer; and then 23.96 g of a silica dispersion liquid (SnowtexC available from Nissan Chemical Corporation, particle size: 10 to 15 nm, silica solids: 20 wt %) was added and stirred for another 15 minutes. The obtained coating composition was coated onto an aluminum base material which had been subjected to a primer treatment using the method described above, and thus a coating film sample was produced.

Fluoro oil content relative to the total amount of resin solids and oil of the fluororesin coating composition: 7.0 wt %, and filler (silica) content relative to the total amount of resin solids and filler of the fluororesin coating composition: 3.0 wt %

### Example 4

As fluoro oil, 11.10 g of PFPE (Krytox XHT1000, available from The Chemours Company, decomposition temperature 426° C.) and 22.19 g of a fluorine based surfactant (FS-31, available from The Chemours Company) were placed in a 1 liter stainless steel beaker; ultrasonic dispersion treatment was performed for 5 minutes using an ultrasonic generator (Ultrasonic MINIWELDER HS3-4, available from Ultrasonic Engineering Co., Ltd.); then as fluororesin (PFA) water based coating for top coat, 419.66 g of EJ-500CL (average particle size of included PFA: approximately 0.2 μm, melting point: 309° C., PFA resin solids: 35 wt %), available from Chemours-Mitsui Fluoroproducts Co., Ltd., was added; the mixture was stirred for 5 minutes in 300 rpm using a downflow type propeller type 4-bladed stirrer; and then 47.05 g of a silica dispersion liquid (SnowtexC available from Nissan Chemical Corporation, particle size: 10 to 15 nm, silica solids: 20 wt %) was added and stirred for another 15 minutes. The obtained coating composition was coated onto an aluminum base material which had been subjected to a primer treatment using the method described above, and thus a coating film sample was produced.

Fluoro oil content relative to the total amount of resin solids and oil of the fluororesin coating composition: 7.0 wt %, and filler (silica) content relative to the total amount of resin solids and filler of the fluororesin coating composition: 6.0 wt %

### Comparative Example 1

A coating film sample was produced by coating 1.0 g of Teflon (Registered Trademark) PFA powder coating MJ-102 available from Chemours-Mitsui Fluoroproducts Co., Ltd. (average particle size: approximately 20 μm, melting point: 309° C.) onto an aluminum base material (JIS A5052 compliant product, 50 mm×100 mm, 1 mm thick) primed according to the method described above, and then firing for 20 minutes at 380° C. The coating film consists of only PFA and does not include fillers or oils.

### Comparative Example 2

As fluoro oil, 12.25 g of PFPE (Krytox XHT1000, available from Chemours Company, decomposition temperature 426° C.) and 24.5 g of a fluorine based surfactant (FS-31, available from Chemours Company) were placed in a 1 liter stainless steel beaker; ultrasonic dispersion treatment was performed for 5 minutes using an ultrasonic generator (Ultrasonic MINIWELDER HS3-4, available from Ultrasonic Engineering Co., Ltd.); then as fluororesin (PFA) water based coating for top coat, 463.25 g of EJ-500CL (average particle size of included PFA: approximately 0.2 μm, melting point: 309° C., PFA resin solids: 35 wt %), available from Chemours-Mitsui Fluoroproducts Co., Ltd., was added; the mixture was stirred for 15 minutes in 300 rpm using a downflow type propeller type 4-bladed stirrer. The obtained coating composition was coated onto an aluminum base material which had been subjected to a primer treatment using the method described above, and thus a coating film sample was produced.

Fluoro oil content relative to the total amount of resin solids and oil of the fluororesin coating composition: 7.0 wt %

### Comparative Example 3

As fluoro oil, 12.13 g of PFPE (Krytox XHT1000, available from Chemours Company, decomposition temperature 426° C.) and 24.25 g of a fluorine based surfactant (FS-31, available from Chemours Company) were placed in a 1 liter stainless steel beaker; ultrasonic dispersion treatment was performed for 5 minutes using an ultrasonic generator (Ultrasonic MINIWELDER HS3-4, available from Ultrasonic Engineering Co., Ltd.); then as fluororesin (PFA) water based coating for top coat, 458.64 g of EJ-500CL (average particle size of included PFA: approximately 0.2 μm, melting point: 309° C., PFA resin solids: 35 wt %), available from Chemours-Mitsui Fluoroproducts Co., Ltd., was added; the mixture was stirred for 5 minutes in 300 rpm using a downflow type propeller type 4-bladed stirrer; and then 4.98 g of silica powder (FB-SSDC available from Denka Company Limited, particle size: 4.1 μm) was added and stirred for another 15 minutes. The obtained coating composition was coated onto an aluminum base material which had been subjected to a primer treatment using the method described above, and thus a coating film sample was produced.

Fluoro oil content relative to the total amount of resin solids and oil of the fluororesin coating composition: 7.0 wt %, and filler (silica) content relative to the total amount of resin solids and filler of the fluororesin coating composition: 3.0 wt %

### Comparative Example 4

As fluoro oil, 12.13 g of PFPE (Krytox XHT1000, available from Chemours Company, decomposition temperature 426° C.) and 24.25 g of a fluorine based surfactant (FS-31, available from Chemours Company) were placed in a 1 liter stainless steel beaker; ultrasonic dispersion treatment was performed for 5 minutes using an ultrasonic generator (Ultrasonic MINIWELDER HS3-4, available from Ultrasonic Engineering Co., Ltd.); then as fluororesin (PFA) water based coating for top coat, 458.64 g of EJ-500CL (average particle size of included PFA: approximately 0.2 μm, melting point: 309° C., PFA resin solids: 35 wt %), available from Chemours-Mitsui Fluoroproducts Co., Ltd., was added; the mixture was stirred for 5 minutes in 300 rpm using a downflow type propeller type 4-bladed stirrer; and then 4.98 g of silica powder (SFP-30M available from Denka Company Limited, particle size: 0.6 μm) was added and stirred for another 15 minutes. The obtained coating composition was coated onto an aluminum base material which had been subjected to a primer treatment using the method described above, and thus a coating film sample was produced.

Fluoro oil content relative to the total amount of resin solids and oil of the fluororesin coating composition: 7.0 wt %, and filler (silica) content relative to the total amount of resin solids and filler of the fluororesin coating composition: 3.0 wt %

### Comparative Example 5

As fluoro oil, 12.13 g of PFPE (Krytox XHT1000, available from Chemours Company, decomposition temperature 426° C.) and 24.25 g of a fluorine based surfactant (FS-31, available from Chemours Company) were placed in a 1 liter stainless steel beaker; ultrasonic dispersion treatment was performed for 5 minutes using an ultrasonic generator (Ultrasonic MINIWELDER HS3-4, available from Ultrasonic Engineering Co., Ltd.); then as fluororesin (PFA) water based coating for top coat, 458.64 g of EJ-500CL (average particle size of included PFA: approximately 0.2 μm, melting point: 309° C., PFA resin solids: 35 wt %), available from Chemours-Mitsui Fluoroproducts Co., Ltd., was added; the mixture was stirred for 5 minutes in 300 rpm using a downflow type propeller type 4-bladed stirrer; and then 4.98 g of silica powder (SFP-20M available from Denka Company Limited, particle size: 0.4 μm) was added and stirred for another 15 minutes. The obtained coating composition was coated onto an aluminum base material which had been subjected to a primer treatment using the method described above, and thus a coating film sample was produced.

Fluoro oil content relative to the total amount of resin solids and oil of the fluororesin coating composition: 7.0 wt %, and filler (silica) content relative to the total amount of resin solids and filler of the fluororesin coating composition: 3.0 wt %

### Example 5

As fluoro oil, 11.78 g of PFPE (Krytox XHT1000, available from Chemours Company, decomposition temperature 426° C.) and 23.55 g of a fluorine based surfactant (FS-31, available from Chemours Company) were placed in a 1 liter stainless steel beaker; ultrasonic dispersion treatment was performed for 5 minutes using an ultrasonic generator (Ultrasonic MINIWELDER HS3-4, available from Ultrasonic Engineering Co., Ltd.); then as fluororesin (PFA) water based coating for top coat, 445.32 g of EJ-500CL (average particle size of included PFA: approximately 0.2 μm, melting point: 309° C., PFA resin solids: 35 wt %), available from Chemours-Mitsui Fluoroproducts Co., Ltd., was added; the mixture was stirred for 5 minutes in 300 rpm using a downflow type propeller type 4-bladed stirrer; and then 19.35 g of a carbon black (which may be referred to as “CB” hereinafter) dispersion liquid (CB853-4297 available from Chemours Company, average particle size (d50): 0.15 μm, CB solids: 25 wt %) was added and stirred for another 15 minutes. The obtained coating composition was coated onto an aluminum base material which had been subjected to a primer treatment using the method described above, and thus a coating film sample was produced.

Fluoro oil content relative to the total amount of resin solids and oil of the fluororesin coating composition: 7.0 wt %, and filler (CB) content relative to the total amount of resin solids and filler of the fluororesin coating composition: 3.0 wt %

### Example 6

As fluoro oil, 11.62 g of PFPE (Krytox XHT1000, available from Chemours Company, decomposition temperature 426° C.) and 23.24 g of a fluorine based surfactant (FS-31, available from Chemours Company) were placed in a 1 liter stainless steel beaker; ultrasonic dispersion treatment was performed for 5 minutes using an ultrasonic generator (Ultrasonic MINIWELDER HS3-4, available from Ultrasonic Engineering Co., Ltd.); then as fluororesin (PFA) water based coating for top coat, 439.42 g of EJ-500CL (average particle size of included PFA: approximately 0.2 μm, melting point: 309° C., PFA resin solids: 35 wt %), available from Chemours-Mitsui Fluoroproducts Co., Ltd., was added; the mixture was stirred for 5 minutes in 300 rpm using a downflow type propeller type 4-bladed stirrer; and then 25.73 g of a CB dispersion liquid (CB853-4297 available from The Chemours Company, average particle size (d50): 0.15 μm, CB solids: 25 wt %) was added and stirred for another 15 minutes. The obtained coating composition was coated onto an aluminum base material which had been subjected to a primer treatment using the method described above, and thus a coating film sample was produced.

Fluoro oil content relative to the total amount of resin solids and oil of the fluororesin coating composition: 7.0 wt %, and filler (CB) content relative to the total amount of resin solids and filler of the fluororesin coating composition: 4.0 wt %

### Example 7

As fluoro oil, 11.31 g of PFPE (Krytox XHT1000, available from The Chemours Company, decomposition temperature 426° C.) and 22.62 g of a fluorine based surfactant (FS-31, available from Chemours Company) were placed in a 1 liter stainless steel beaker; ultrasonic dispersion treatment was performed for 5 minutes using an ultrasonic generator (Ultrasonic MINIWELDER HS3-4, available from Ultrasonic Engineering Co., Ltd.); then as fluororesin (PFA) water based coating for top coat, 427.71 g of EJ-500CL (average particle size of included PFA: approximately 0.2 μm, melting point: 309° C., PFA resin solids: 35 wt %), available from Chemours-Mitsui Fluoroproducts Co., Ltd., was added; the mixture was stirred for 5 minutes in 300 rpm using a downflow type propeller type 4-bladed stirrer; and then 38.36 g of a CB dispersion liquid (CB853-4297 available from Chemours Company, average particle size (d50): 0.15 μm, CB solids: 25 wt %) was added and stirred for another 15 minutes. The obtained coating composition was coated onto an aluminum base material which had been subjected to a primer treatment using the method described above, and thus a coating film sample was produced.

Fluoro oil content relative to the total amount of resin solids and oil of the fluororesin coating composition: 7.0 wt %, and filler (CB) content relative to the total amount of resin solids and filler of the fluororesin coating composition: 6.0 wt %

### Example 8

As fluoro oil, 11.44 g of PFPE (Krytox XHT1000, available from Chemours Company, decomposition temperature 426° C.) and 22.89 g of a fluorine based surfactant (FS-31, available from The Chemours Company) were placed in a 1 liter stainless steel beaker; ultrasonic dispersion treatment was performed for 5 minutes using an ultrasonic generator (Ultrasonic MINIWELDER HS3-4, available from Ultrasonic Engineering Co., Ltd.); then as fluororesin (PFA) water based coating for top coat, 432.81 g of EJ-500CL (average particle size of included PFA: approximately 0.2 μm, melting point: 309° C., PFA resin solids: 35 wt %), available from Chemours-Mitsui Fluoroproducts Co., Ltd., and a fluororesin (PTFE) water based dispersion liquid, 28.16 g of Teflon (Registered Trademark) PTFE 31-JR (average particle size of included PTFE: approximately 220 nm, PTFE resin solids: 60 wt %) available from Chemours-Mitsui Fluoroproducts Co., Ltd., were added; the mixture was stirred for 5 minutes in 300 rpm using a downflow type propeller type 4-bladed stirrer; and then 4.70 g of a SiC powder (P600 available from ESK-SiC GmbH, average particle size (d50): 25.8 μm) was added and stirred for another 15 minutes. The obtained coating composition was coated onto an aluminum base material which had been subjected to a primer treatment using the method described above, and thus a coating film sample was produced.

Fluoro oil content relative to the total amount of resin solids and oil of the fluororesin coating composition: 7.0 wt %, filler (SiC) content relative to the total amount of resin solids and filler of the fluororesin coating composition: 2.7 wt %, and PTFE content relative to resin solids of the fluororesin coating composition: 10 wt %

### Example 9

As fluoro oil, 10.69 g of PFPE (Krytox XHT1000, available from Chemours Company, decomposition temperature 426° C.) and 21.38 g of a fluorine based surfactant (FS-31, available from The Chemours Company) were placed in a 1 liter stainless steel beaker; ultrasonic dispersion treatment was performed for 5 minutes using an ultrasonic generator (Ultrasonic MINIWELDER HS3-4, available from Ultrasonic Engineering Co., Ltd.); then as fluororesin (PFA) water based coating for top coat, 404.35 g of EJ-500CL (average particle size of included PFA: approximately 0.2 μm, melting point: 309° C., PFA resin solids: 35 wt %), available from Chemours-Mitsui Fluoroproducts Co., Ltd., and a fluororesin (PTFE) water based dispersion liquid, 59.19 g of Teflon PTFE 31-JR (average particle size of included PTFE: approximately 220 nm, PTFE resin solids: 60 wt %) available from Chemours-Mitsui Fluoroproducts Co., Ltd., were added; the mixture was stirred for 5 minutes in 300 rpm using a downflow type propeller type 4-bladed stirrer; and then 4.39 g of a SiC powder (P600 available from ESK-SiC GmbH, average particle size (d50): 25.8 μm) was added and stirred for another 15 minutes. The obtained coating composition was coated onto an aluminum base material which had been subjected to a primer treatment using the method described above, and thus a coating film sample was produced.

Fluoro oil content relative to the total amount of resin solids and oil of the fluororesin coating composition: 7.0 wt %, filler (SiC) content relative to the total amount of resin solids and filler of the fluororesin coating composition: 2.4 wt %, and PTFE content relative to resin solids of the fluororesin coating composition: 20 wt %

### Comparative Example 6

As fluoro oil, 12.13 g of PFPE (Krytox XHT1000, available from Chemours Company, decomposition temperature 426° C.) and 24.25 g of a fluorine based surfactant (FS-31, available from The Chemours Company) were placed in a 1 liter stainless steel beaker; ultrasonic dispersion treatment was performed for 5 minutes using an ultrasonic generator (Ultrasonic MINIWELDER HS3-4, available from Ultrasonic Engineering Co., Ltd.); then as fluororesin (PFA) water based coating for top coat, 458.64 g of EJ-500CL (average particle size of included PFA: approximately 0.2 μm, melting point: 309° C., PFA resin solids: 35 wt %), available from Chemours-Mitsui Fluoroproducts Co., Ltd., was added; the mixture was stirred for 5 minutes in 300 rpm using a downflow type propeller type 4-bladed stirrer; and then 4.98 g of SiC powder (available from ESK-SiC GmbH, particle size (d50): 25.8 μm) was added and stirred for another 15 minutes. The obtained coating composition was coated onto an aluminum base material which had been subjected to a primer treatment using the method described above, and thus a coating film sample was produced.

Fluoro oil content relative to the total amount of resin solids and oil of the fluororesin coating composition: 7.0 wt %, and filler (SiC) content relative to the total amount of resin solids and filler of the fluororesin coating composition: 3.0 wt %

### Comparative Example 7

While stirring, as fluororesin (PFA) water based coating for top coat, 474.24 g of EJ-500CL (average particle size of included PFA: approximately 0.2 μm, melting point: 309° C., PFA resin solids: 35 wt %), available from Chemours-Mitsui Fluoroproducts Co., Ltd., for 5 minutes in 300 rpm using a downflow type propeller type 4-bladed stirrer, 25.76 g of a silica dispersion liquid (SnowtexC available from Nissan Chemical Corporation, particle size: 10 to 15 nm, silica solids: 20 wt %) was added and stirred for another 15 minutes. The obtained coating composition was coated onto an aluminum base material which had been subjected to a primer treatment using the method described above, and thus a coating film sample was produced.

Filler (silica) content relative to the total amount of resin solids and filler of the fluororesin coating composition: 3.0 wt %

TABLE 1

| | | | | | | | | n- | |
|---|---|---|---|---|---|---|---|---|---|
| | | | | | | | | hexadecane | |
| | | | Average | | | Oil | Molded | contact | |
| | Fluoro- | Filler | particle | | | content*2 | product | angle | Suga WR |
| | resin | Type | size | | Content*1 | [wt %] | glossiness | [°] | (ds/μm) |
| Example 1 | PFA | Silica | 10-15 | nm | 1.0% | 7.0% | 6.8 | — | 42.0 |
| Example 2 | PFA | Silica | 10-15 | nm | 2.0% | 7.0% | 4.0 | — | — |
| Example 3 | PFA | Silica | 10-15 | nm | 3.0% | 7.0% | 0.7 | 61.8 | — |
| Example 4 | PFA | Silica | 10-15 | nm | 6.0% | 7.0% | 0.3 | 62.9 | — |
| Example 5 | PFA | CB | Ca. 150 | | 3.0% | 7.0% | 5.7 | 68.1 | 52.6 |
| | | | nm | | | | | | |
| Example 6 | PFA | CB | Ca. 150 | | 4.0% | 7.0% | 3.5 | 70.2 | 53.3 |
| | | | nm | | | | | | |
| Example 7 | PFA | CB | Ca. 150 | | 6.0% | 7.0% | 1.5 | 65.0 | 58.7 |
| | | | nm | | | | | | |
| Example 8 | PFA, | SiC | 25.8 | μm | 2.7% | 7.0% | 6.0 | 71.3 | 50.5 |
| | PTFE | PTFE | Ca. 220 | | 10% | | | | |
| | | | nm | | | | | | |
| Example 9 | PFA, | SiC | 25.8 | μm | 2.4% | 7.0% | 1.9 | 71.8 | 55.5 |
| | PTFE | PTFE | Ca. 220 | | 20% | | | | |
| | | | nm | | | | | | |
| Comparative | PFA | — | | | | — | 15.8 | 56.4 | 41.0 |
| Example 1 | | | | | | | | | |
| Comparative | PFA | — | | | | 7.0% | 21.5 | 64.9 | — |
| Example 2 | | | | | | | | | |
| Comparative | PFA | Silica | 4.1 | μm | 3.0% | 7.0% | 14.4 | — | — |
| Example 3 | | | | | | | | | |
| Comparative | PFA | Silica | 0.6 | μm | 3.0% | 7.0% | 13.4 | — | — |
| Example 4 | | | | | | | | | |
| Comparative | PFA | Silica | 0.4 | μm | 3.0% | 7.0% | 10.0 | — | — |
| Example 5 | | | | | | | | | |
| Comparative | PFA | | 25.8 | μm | 3.0% | 7.0% | 8.3 | 71.5 | 65.0 |
| Example 6 | | | | | | | | | |
| Comparative | PFA | Silica | 10-15 | nm | 3.0% | — | 3.1 | 52.5 | — |
| Example 7 | | | | | | | | | |

*1Ratio to the total weight (coating solids) of resin solids (weight of fluororesin included in coating composition) and filler
*2Ratio to the total weight of resin solids and oil

In the present method for manufacturing a molded product, a molded product made from a polymer material having a matte surface with suppressed surface gloss can be molded with good productivity, and in particular, and the method can be suitably used in the manufacture of a molded product in which the surface is preferably matte, such as tires.

1. A method for manufacturing a molded product, comprising forming said product in a mold having a coating on the surface of said mold, wherein said coating comprises a layer of fluororesin having dispersed therein oil and filler having an average particle size of 300 nm or less.

2. The manufacturing method according to claim 1, wherein the glossiness of said molded product is less than 8.

3. The manufacturing method according to claim 1, wherein said fluororesin is a melt processable perfluoro resin.

4. The manufacturing method according to claim 1, wherein said oil is an oil that is in the liquid state at 25° C. and pressure of one atmosphere.

5. The manufacturing method according to claim 1, wherein the content of said oil in said coating is 1 to 35 wt % based on the total amount of fluororesin and oil in said coating.

6. The manufacturing method according to claim 1, wherein the content of said filler in said coating is 1 to 10 wt % based on the total amount of fluororesin and filler in said coating.

7. A molded product made from a melt processible polymer, the molded product being molded in a mold having a coating on the surface of said mold, wherein said coating comprises a layer of fluororesin having dispersed therein oil and filler having an average particle size of 300 nm or less, wherein said molded product has a glossiness of less than 8.
